(19) United States
(12) Patent Application Publication
(10) Pub. No.: US 2025/0305849 A1
(43) Pub. Date: Oct. 2, 2025

(54) SYSTEMS AND METHODS FOR GENERATING MAP DATA

(71) Applicant: Toyota Jidosha Kabushiki Kaisha, Toyota-shi Aichi-ken (JP)

(72) Inventors: Kartik Patath, Sunnyvale, CA (US); Eitan Gilad Mendelowitz, Northampton, MA (US)

(21) Appl. No.: 18/621,360

(22) Filed: Mar. 29, 2024

(51) Int. Cl. G01C 21/00; B60W 60/00; G06T 7/73

(52) U.S. Cl. CPC G01C 21/3811; G01C 21/3815; G06T 7/73; G06T 2207/30256

(57) ABSTRACT

Systems and methods for generating map data are disclosed herein. One embodiment of a map-data generation system receives, from one or more vehicles that traveled within a region, a set of estimated locations for each landmark in a plurality of landmarks within the region. The system also generates a base zone map of the region that represents roadways as edges and intersections as junctions. The system also transforms, to edge-relative coordinates, the spatial coordinates of the sets of estimated locations. The edge-relative coordinates improve a Global Nearest Neighbor (GNN) algorithm in performing data association to generate a final estimated location for each landmark. The system also outputs a final zone map that includes the final estimated location for at least one landmark. The final zone map is used for one or more of localization, navigation, and path planning to control an autonomous vehicle.

### TECHNICAL FIELD

The subject matter described herein generally relates to autonomous vehicles and, more particularly, to systems and methods for generating map data used in controlling autonomous vehicles and for other applications.

### BACKGROUND

Autonomous vehicles depend on accurate and up-to-date map data to perform tasks such as localization, navigation, and path planning. One approach to generating map data includes using data captured by multiple vehicles that drive around within a geographical area. Fusing this kind of input data to produce a map that includes accurate locations for landmarks such as traffic signs and roadway features can be challenging due to sensor noise, noise in Global-Positioning-System (GPS) signals, noise in the machine-vision algorithms in the vehicles, and occlusions (view obstructions).

### SUMMARY

An example of a system for generating map data is presented herein. The system comprises a processor and a memory storing machine-readable instructions that, when executed by the processor, cause the processor to receive, from one or more vehicles that traveled within a region, a set of estimated locations for each landmark in a plurality of landmarks within the region. The memory also stores machine-readable instructions that, when executed by the processor, cause the processor to generate a base zone map of the region that represents roadways as edges and intersections as junctions. The memory also stores machine-readable instructions that, when executed by the processor, cause the processor to transform, to edge-relative coordinates, the spatial coordinates of the set of estimated locations for each landmark in the plurality of landmarks. The edge-relative coordinates are defined in terms of a distance along an edge of the base zone map and an offset from that edge to improve a Global Nearest Neighbor (GNN) algorithm in performing data association to generate a final estimated location for each landmark in the plurality of landmarks. The memory also stores machine-readable instructions that, when executed by the processor, cause the processor to output a final zone map that includes the final estimated location for at least one landmark in the plurality of landmarks. The final zone map is used for one or more of localization, navigation, and path planning to control an autonomous vehicle.

Another embodiment is a non-transitory computer-readable medium for generating map data and storing instructions that when executed by a processor cause the processor to receive, from one or more vehicles that traveled within a region, a set of estimated locations for each landmark in a plurality of landmarks within the region. The instructions also cause the processor to generate a base zone map of the region that represents roadways as edges and intersections as junctions. The instructions also cause the processor to transform, to edge-relative coordinates, the spatial coordinates of the set of estimated locations for each landmark in the plurality of landmarks. The edge-relative coordinates are defined in terms of a distance along an edge of the base zone map and an offset from that edge to improve a GNN algorithm in performing data association to generate a final estimated location for each landmark in the plurality of landmarks. The instructions also cause the processor to output a final zone map that includes the final estimated location for at least one landmark in the plurality of landmarks. The final zone map is used for one or more of localization, navigation, and path planning to control an autonomous vehicle.

In another embodiment, a method of generating map data is disclosed. The method comprises receiving, from one or more vehicles that traveled within a region, a set of estimated locations for each landmark in a plurality of landmarks within the region. The method also includes generating a base zone map of the region that represents roadways as edges and intersections as junctions. The method also includes transforming, to edge-relative coordinates, the spatial coordinates of the set of estimated locations for each landmark in the plurality of landmarks. The edge-relative coordinates are defined in terms of a distance along an edge of the base zone map and an offset from that edge to improve a GNN algorithm in performing data association to generate a final estimated location for each landmark in the plurality of landmarks. The method also includes outputting a final zone map that includes the final estimated location for at least one landmark in the plurality of landmarks. The final zone map is used for one or more of localization, navigation, and path planning to control an autonomous vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a vehicle that can use the map data generated via various embodiments of the systems and methods disclosed herein.

FIG. 2 is a diagram of an environment in which various illustrative embodiments of a map-data generation system can be implemented.

FIGS. 3A and 3B are diagrams of connected-vehicle trips in which the respective locations of landmarks within a region are estimated, in accordance with an illustrative embodiment of the invention.

FIG. 4 is a diagram of a region in which the spatial coordinates of landmarks are transformed to edge-relative coordinates, in accordance with an illustrative embodiment of the invention.

FIG. 5 is a block diagram of a map-data generation system, in accordance with an illustrative embodiment of the invention.

FIG. 6 is a flowchart of a method of generating map data, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Various embodiments of systems and methods for generating map data described herein overcome difficulties in building accurate map data based on input data from a plurality of vehicles through improved data association that helps to reconcile disparate estimated locations, in the input data, of detected landmarks. As mentioned in the Background, variability in estimated landmark locations can result from, for example, sensor noise, noise in Global-Positioning-System (GPS) signals, noise in machine-vision algorithms in the vehicles, and occlusions (view obstructions).

In embodiments, a map-data generation system receives, from one or more vehicles that have traveled within a region, a set of estimated locations for each landmark in a plurality of landmarks within the region. The system generates a base zone map of the region that represents roadways as edges and intersections as junctions (also sometimes referred to in the art as vertices or nodes). The base zone map is generated once for a given region and is then updated periodically or as needed. The system improves data association, as mentioned above, by transforming, to edge-relative coordinates, the spatial coordinates of the set of estimated locations for each landmark in the plurality of landmarks. The edge-relative coordinates are defined in terms of a distance along an edge of the base zone map and an offset from that edge. This improves the performance of a Global Nearest Neighbor (GNN) algorithm in performing data association to generate a final estimated location for each landmark in the plurality of landmarks.

The improved data association stems from the edge-relative coordinates clarifying spatial relationships among the plurality of landmarks with respect to one or more edges in the base zone map to assist the GNN algorithm in identifying, from the sets of estimated locations for the landmarks in the plurality of landmarks, a cluster of candidate (possible, likely) locations for each landmark in the plurality of landmarks. This is particularly helpful when landmarks are close to one another (e.g., two traffic signals at an intersection are close to each other), resulting in ambiguity in the actual locations of the landmarks due to interleaving (overlap) of the clusters of estimated locations associated with the individual landmarks.

The system outputs a final zone map of the region that includes the final estimated location of at least one landmark in the plurality of landmarks. The final zone map is used for localization, navigation, and/or path planning to control an autonomous vehicle. In some embodiments, the system also compares the final zone map with an earlier version of the final zone map to identify and output changes in landmarks within the region. That is, the final zone map is used for landmark inventory and change-detection, in some embodiments.

In some embodiments, the estimated landmark locations the map-data generation system receives from the vehicles are derived from machine-vision-based perception systems in the vehicles that process raw sensor data output by sensors in the vehicles.

In some embodiments, the spatial coordinates of the estimated landmark locations include latitude and longitude. In other embodiments, the spatial coordinates of the estimated landmark locations include latitude, longitude, and a height dimension (e.g., height above a specified ground-level reference).

In various embodiments, the landmarks can include, without limitation, traffic signs, traffic signal lights, and roadway features (e.g., roundabouts, pedestrian crossings, guard cables, onramps, offramps, diamond-type interchanges, etc.).

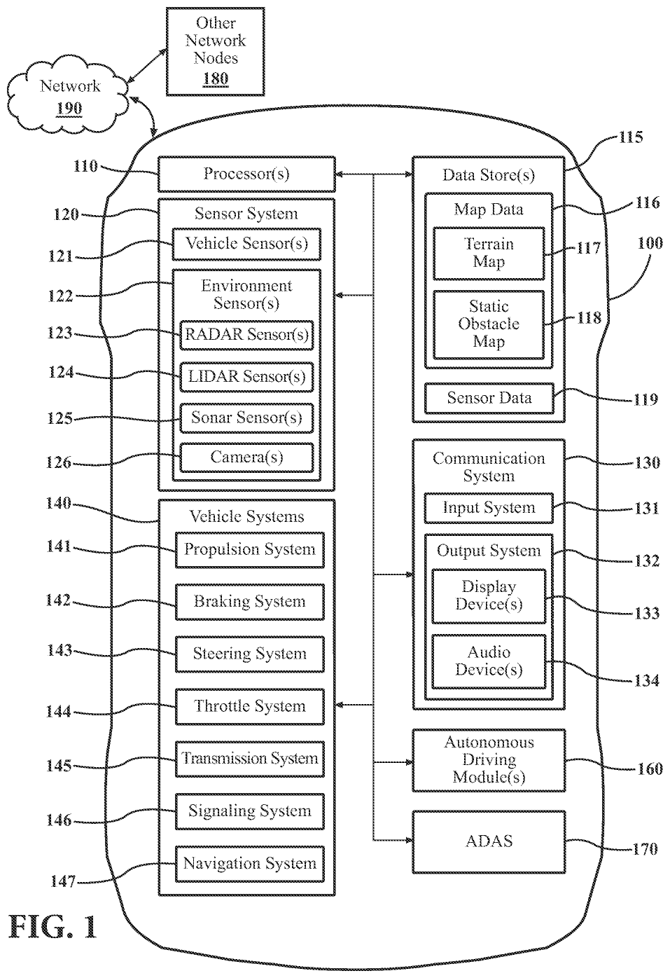

Referring to FIG. 1, it depicts a vehicle 100 that can receive and use map data generated via various embodiments of map-data generation systems and methods to be discussed in greater detail below. As used herein, a “vehicle” is any form of motorized transport. One example of a “vehicle,” without limitation, is an automobile.

In embodiments, vehicle 100 includes an autonomous driving system that enables vehicle 100 to operate in a semi-autonomous or autonomous driving mode at least some of the time. For example, in some embodiments, vehicle 100 can operate at a high or total level of autonomy (e.g., Society of Automotive Engineers Autonomy Levels 3-5). In other embodiments, vehicle 100 can operate in a semi-autonomous driving mode by virtue of features such as adaptive cruise-control, automatic lane-change assistance, and automatic parking assistance. In still other embodiments, vehicle 100 can operate in a semi-autonomous driving mode via an intelligent driving assistance system such as an Advanced Driver-Assistance System (ADAS). In some embodiments, the ADAS can intervene (e.g., temporarily take control of acceleration/deceleration and/or steering) to avoid a collision or other accident. In still other embodiments, vehicle 100 may be driven manually by a human driver.

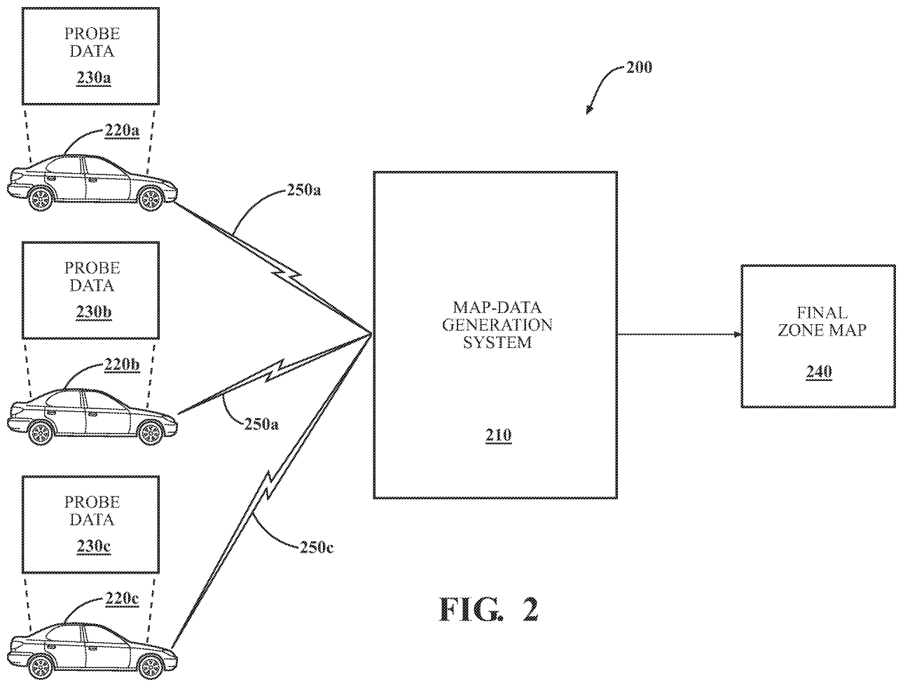

As indicated in FIG. 1, the vehicle 100 includes various elements. It will be understood that, in various implementations, it may not be necessary for the vehicle 100 to have all the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. Some of the possible elements of the vehicle 100 are shown in FIG. 1. However, a description of many of the elements in FIG. 1 will be provided after the discussion of FIGS. 2-6 for purposes of brevity of this description. As shown in FIG. 1, vehicle 100 is equipped with an autonomous driving system that includes one or more autonomous driving module(s) 160 and/or an ADAS 170. A number of other elements support the autonomous driving system of vehicle 100, as explained further below.

Sensor system 120 can include one or more vehicle sensors 121. Vehicle sensors 121 can include one or more positioning systems such as a dead-reckoning system or a global navigation satellite system (GNSS) such as a global positioning system (GPS). Vehicle sensors 121 can also include Controller-Area-Network (CAN) sensors that output, for example, speed and steering-angle data pertaining to vehicle 100. Sensor system 120 can also include one or more environment sensors 122. Environment sensors 122 generally include, without limitation, radar sensor(s) 123, Light Detection and Ranging (LIDAR) sensor(s) 124, sonar sensor(s) 125, and camera(s) 126. One or more of these various types of environment sensors 122 can be used to detect objects (e.g., external road agents such as other vehicles, bicyclists, motorcyclists, pedestrians, and animals) and, in other respects, understand the environment surrounding vehicle 100 and its associated traffic situations and conditions. This process is sometimes referred to as “traffic-situation understanding” or “scene understanding.”

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. In one or more arrangement, the map data 116 can include one or more terrain maps 117. The terrain map(s) 117 can include information about the ground, terrain, roads, surfaces, and/or other features of one or more geographic areas. In one or more arrangement, the map data 116 can include one or more static obstacle maps 118. The static obstacle map(s) 118 can include information about one or more static obstacles located within one or more geographic areas.

The one or more data stores 115 can include sensor data 119. In this context, “sensor data” means any information about the sensors that a vehicle is equipped with, including the capabilities and other information about such sensors. As explained above, vehicle 100 can include a sensor system 120. The sensor data 119 can relate to one or more sensors of the sensor system 120. As an example, in one or more arrangements, the sensor data 119 can include information from one or more cameras 126 and/or LIDAR sensors 124 of the sensor system 120. In some embodiments, vehicle 100 can receive sensor data from other connected vehicles, from devices associated with other road users (ORUs), or both.

In some embodiments, vehicle 100 receives final zone maps generated by a map-data generation system in accordance with the principles and techniques described herein, and those final zone maps become part of the map data 116 discussed above. In those embodiments, the final zone maps in map data 116 are used in conjunction with autonomous driving module(s) 160 for localization, navigation, and/or path planning in vehicle 100 to control the operation of vehicle 100 when vehicle 100 is operating in an autonomous driving mode. That is, the final zone maps, in combination with other components and subsystems of vehicle 100, are used to control the steering, acceleration, deceleration, and braking of vehicle 100. As mentioned above, in some embodiments, the final zone maps are also used for landmark inventory and change-detection. For example, the map-data generation system can compare a final zone map with an earlier version of the final zone map for the same region to detect changes in the landmarks within a region (e.g., new landmarks, landmarks that have been removed, landmarks that have been altered, etc.).

As shown in FIG. 1, vehicle 100, in some embodiments, can communicate with other network nodes 180 (e.g., connected vehicles, cloud servers, edge servers, roadside units, infrastructure) via a network 190. In some embodiments, network 190 includes the Internet.

FIG. 2 is a diagram of an environment 200 in which various illustrative embodiments of a map-data generation system can be implemented. As shown in FIG. 2, environment 200 includes one or more connected vehicles 220 that have driven within a particular region of interest during a specified time period. The size of the region varies, depending on the embodiment. In some embodiments, the region is relatively small (e.g., a segment of roadway 50 to 100 m long). In other embodiments, the region is somewhat larger (e.g., a roadway segment several city blocks long, a neighborhood, or a section of a town or city).

Three connected vehicles 220a-c are depicted in FIG. 2 for purposes of illustration only. In some embodiments, many more connected vehicles 220 than three can be involved in providing the estimated-location data for landmarks within the region that is input to a map-data generation system 210. For example, in one embodiment, map-data generation system 210 processes estimated-location data for landmarks within the region from 50, 60, or 100 traces recorded by connected vehicles 220 over a two-week period.

In each connected vehicle 220, onboard sensors such as the environment sensors 122 of vehicle 100 discussed above, particularly camera(s) 126, capture data pertaining to the region to be mapped. One or more perception systems (e.g., machine-vision-based algorithms) in the connected vehicle 220 process and analyze the raw sensor data 119 to perform object recognition, object tracking, object location/position estimation, etc. Among the recognized objects in the environment are landmarks. As discussed above, herein, “landmarks” include, without limitation, traffic signs, traffic signal lights, and various kinds of roadway features.

The probe data 230 output by each connected vehicle 220 includes, for each detected and recognized landmark within the region, an identifying label (e.g., “stop sign”), the estimated location (e.g., latitude and longitude) of the landmark, and the location (e.g., latitude and longitude) of the connected vehicle 220 at the time the raw sensor data from which the landmark's location was estimated was captured/recorded.

In some embodiments, the probe data 230 is captured serendipitously. That is, the connected vehicles 220 travel within the region of interest and share their respective probe data 230 with map-data generation system 210 without any deliberate planning or intention to support the generation of map data. The connected vehicles 220 thus travel within the region in the ordinary course (e.g., in accordance with the needs of their respective owners/drivers in connection with everyday activities such as work, shopping, recreation, etc.). In other embodiments, one or more connected vehicles 220 can be sent to the region of interest as “probe vehicles” to drive in particular predetermined ways for the express purpose of capturing, from particular vantage points, estimated-location data for landmarks in the region to support map-data generation system 210 in building map data.

Map-data generation system 210 receives, via the wireless-network communication links 250a-c from the connected vehicles 220a-c as part of the probe data 230a-c from the connected vehicles 220a-c, a set of estimated locations for each landmark in a plurality of landmarks within the region. In the example of FIG. 2, each of connected vehicle 220a, connected vehicle 220b, and connected vehicle 220c provides, in its output probe data 230 (230a, 230b, or 230c), an estimated location (e.g., latitude and longitude) of a particular landmark (e.g., a traffic signal light). Those three somewhat different estimated locations for the traffic light constitute a set of estimated locations for that single landmark. This generalizes to additional landmarks, resulting in a set of estimated locations for each landmark in a plurality of landmarks within the region. In some embodiments, the probe data 230 from a given connected vehicle 220 is formatted as a comma-separated-values (CSV) file.

Map-data generation system 210 analyzes the sets of estimated locations for the respective landmarks in the plurality of landmarks in a manner to be described in greater detail below to generate a final estimated location for each landmark in the plurality of landmarks. Map-data generation system 210 then outputs a final zone map 240 of the region in question. The final zone map 240 includes a final estimated location for at least one landmark in the plurality of landmarks.

For a given region, map-data generation system 210 initially generates a base zone map, a graph in accordance with graph theory, in which roadways are represented as edges and intersections (places where roadways meet or cross each other) are represented as junctions (also called “vertices” or “nodes” by those skilled in the art). In some embodiments, the base zone map is generated using data from a map-data source such as OpenStreetMap®. The base zone map represents the basic geometry of the roadways and intersections in the region of interest. The base zone map is generated once for a given region and is then updated periodically or as needed. The trajectory of a given connected vehicle 220 during a trip (from the connected vehicle's probe data 230) can be matched to one or more edges in the base zone map. This is one of the first steps in the process of map building that map-data generation system 210 carries out.

As mentioned above, map-data generation system 210 transforms, to edge-relative coordinates, the spatial coordinates of the set of estimated locations for each landmark in the plurality of landmarks. As discussed in greater detail below, the edge-relative coordinates of a given estimated landmark location are defined in terms of a distance along an edge of the base zone map and an offset from that edge. This improves the performance of a GNN algorithm in carrying out data association to generate the final estimated location for each landmark in the plurality of landmarks. As those skilled in the art are aware, data association is a process in which different landmark location estimates from different connected vehicles 220 or from different trips by the same connected vehicle 220 are reconciled with one another to compute an estimated location for the landmark that has a higher degree of likelihood of being accurate. This involves determining that two estimated locations from two different connected vehicles 220 (or from two different trips by the same connected vehicle 220) refer to the same landmark—that they should be associated with each other.

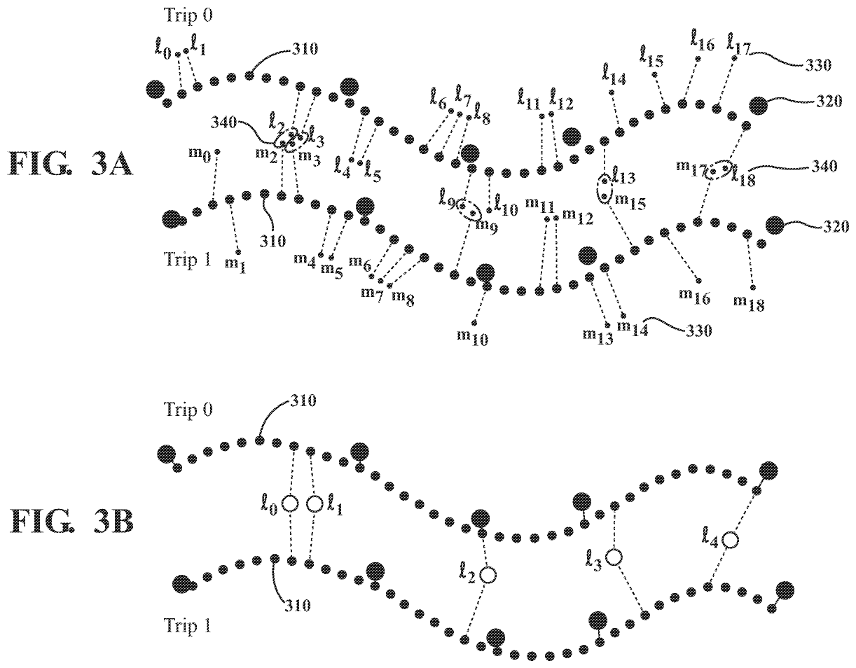

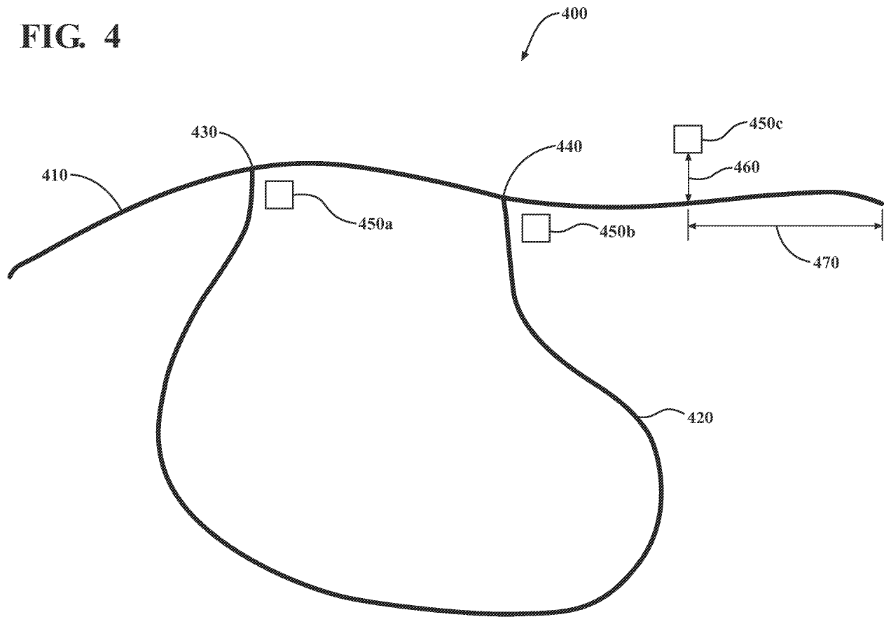

As explained above, the improved data association by the GNN algorithm stems from the edge-relative coordinates clarifying spatial relationships among the plurality of landmarks with respect to one or more edges in the base zone map to assist the GNN algorithm in identifying, from the sets of estimated locations for the landmarks in the plurality of landmarks, a cluster of candidate (possible, likely) locations for each landmark in the plurality of landmarks. This is particularly helpful when landmarks are close to one another (e.g., two traffic signals at an intersection are in close proximity to each other), resulting in ambiguity in the actual locations of the landmarks due to interleaving of the clusters of estimated locations associated with the individual landmarks. This is discussed further below in connection with FIGS. 3A, 3B, and 4.

As shown in FIG. 2, map-data generation system 210 outputs a final zone map 240 that includes the final estimated location for at least one landmark in the plurality of landmarks. In some embodiments, multiple final zone maps 240 from different regions are combined to provide a map covering a larger geographical area (e.g., an entire town or city). As discussed above, a final zone map 240 is used for localization, navigation, and/or path planning to control an autonomous vehicle 100, and the final zone map 240 can, in some embodiments, also be used for landmark inventory and change-detection.

FIGS. 3A and 3B are diagrams of connected-vehicle trips in which the respective locations of landmarks within a region are estimated, in accordance with an illustrative embodiment of the invention. Reference numerals have been omitted from many repeatedly occurring elements in FIG. 3A for clarity. FIG. 3A shows two trips, Trip 0 and Trip 1, by either two different connected vehicles 220 or two different trips by the same connected vehicle 220 at different times. During Trip 0, the connected vehicle 220 produces, as part of its probe data 230, an estimated location for each of a number of different landmarks. Those respective estimated locations are labeled lᵢ, i=0 to 18, in FIG. 3A. In FIG. 3A, the smaller dots (310) represent structure-from-motion (SFM) location estimates of the connected vehicle's trajectory. The larger dots (320) represent GNSS location estimates of the connected vehicle's trajectory.

During Trip 1, the connected vehicle 220 produces, as part of its probe data 230, an estimated location for each of the same plurality of landmarks in the region. Those respective estimated locations are labeled mⱼ, j=0 to 18, in FIG. 3A.

Situations such as that depicted in FIG. 3A involving the estimated locations l₂, m₂, l₃, and m₃ are particularly challenging for a data-association algorithm. In this case, two landmarks (e.g., two traffic signal lights) are close to each other, creating possible ambiguity in the actual locations of the two landmarks. For example, in this case, the data association algorithm could mistakenly cluster l₂ with m₃ and m₂ with l₃ instead of l₂ with m₂ and l₃ with m₃, the latter clustering being the correct one, in this example. Through the use of edge-relative coordinates (discussed further below in connection with FIG. 4), the GNN algorithm in map-data generation system 210 correctly identifies clusters of candidate locations 340 for landmarks such as l₂ with m₂ and l₃ with m₃ and the other illustrative associated pairs of estimated locations circled in FIG. 3A.

The results of using edge-relative coordinates in the GNN algorithm are shown in FIG. 3B. In this example, map-data generation system 210 has calculated a final estimated location lᵢ, i=0 to 4, for five landmarks within the region of interest. Those five landmarks correspond to the illustrative five clusters of candidate locations 340 circled in FIG. 3A. In some embodiments, map-data generation system 210 computes the final estimated location for each landmark in the plurality of landmarks as the centroid of the cluster of candidate locations for that landmark. It should be kept in mind that FIGS. 3A and 3B, showing only two connected-vehicle trips, depict a simpler situation than many that would arise in a practical implementation of map-data generation system 210. As mentioned above, in some embodiments, there could be many more than just two traces (recorded probe data 230 from connected-vehicle trips) and, therefore, many more estimated locations than just two for a given landmark.

FIG. 4 is a diagram of a region 400 in which the spatial coordinates of landmarks are transformed to edge-relative coordinates, in accordance with an illustrative embodiment of the invention. In FIG. 4, a roadway 410 is intersected in two places (at intersections 430 and 440) by another roadway 420. A landmark 450a is near intersection 430, and a landmark 450b is near intersection 440. FIG. 4 also includes a third landmark, landmark 450c. As illustrated in FIG. 4, the latitude and longitude spatial coordinates of an estimated location of landmark 450c obtained from a connected vehicle 220 (in the vehicle's probe data 230) can be converted to edge-relative coordinates. For simplicity, in this example, it is assumed that the estimated location coincides with the actual location of the landmark 450c depicted in FIG. 4. As shown in FIG. 4, the edge-relative coordinates of the estimated location are (1) a distance 470 along an edge of the base zone map (the edge representing roadway 410) and (2) an offset 460 from that edge.

Edge-relative coordinates have the following desirable effect on the data association performed by the GNN algorithm. Two landmarks that are relatively close to each other in Cartesian space (e.g., latitude and longitude coordinates), such as landmark 450a and landmark 450b in FIG. 4, are far apart in edge-coordinates space. This is because the two landmarks 450a and 450b are near opposite ends of the edge representing the roadway 420. This property of the edge-relative coordinates assists the GNN algorithm in identifying, from the sets of estimated locations for the landmarks in the plurality of landmarks, a cluster of candidate locations 340 for each landmark in the plurality of landmarks by clarifying the spatial relationships among the plurality of landmarks with respect to one or more edges in the base zone map. For example, in FIG. 4, the edge-relative coordinates clarify for the GNN algorithm that landmark 450a and landmark 450b are not close together with respect to their positions along roadway 420. Instead, they are at opposite ends of roadway 420 (as far apart as they could be with respect to the edge representing roadway 420).

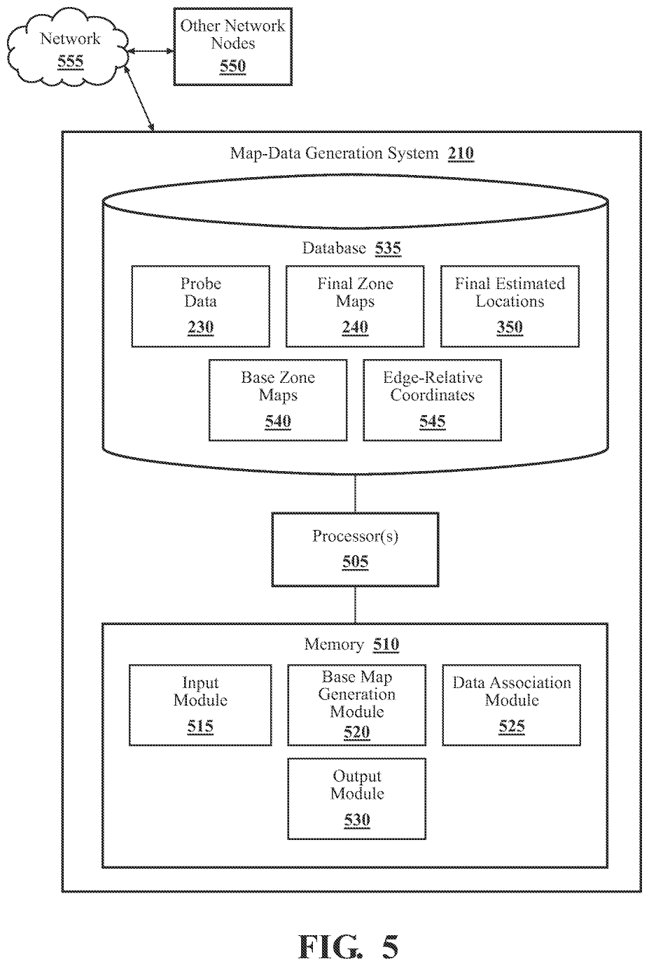

FIG. 5 is a block diagram of a map-data generation system 210, in accordance with an illustrative embodiment of the invention. In FIG. 5, map-data generation system 210 includes one or more processors 505 to which a memory 510 is communicably coupled. Memory 510 stores an input module 515, a base-map generation module 520, a data association module 525, and an output module 530. The memory 510 is a random-access memory (RAM), read-only memory (ROM), a hard-disk drive, a flash memory, or other suitable non-transitory memory for storing the modules 515, 520, 525, and 530. The modules 515, 520, 525, and 530 are, for example, machine-readable instructions that, when executed by the one or more processors 505, cause the one or more processors 505 to perform the various functions disclosed herein. In some embodiments, map-data generation system 210 is implemented in a server. In other embodiments, map-data generation system 210 is implemented in a computer workstation.

As also shown in FIG. 5, map-data generation system 210 can store various kinds of data in a database 535. For example, map-data generation system 210 can store probe data 230, base zone maps 540, edge-relative coordinates 545, final landmark location estimates 350, and final zone maps 240, all of which are discussed above.

As also shown in FIG. 5, map-data generation system 210 can communicate with other network nodes 550 (e.g., connected vehicles 220, servers, etc.) via a network 555. In some embodiments, network 555 includes the Internet. As discussed above in connection with FIG. 2, map-data generation system 210 receives probe data 230 for building final zone maps 240 from connected vehicles 220 via wireless-network communication links 250.

Input module 515 generally includes instructions that, when executed by the one or more processors 505, cause the one or more processors 505 to receive, from one or more vehicles (220) that traveled within a region, a set of estimated locations for each landmark 450 in a plurality of landmarks within the region 400. As discussed above, input module 515 receives, via the wireless-network communication links 250 from the connected vehicles 220 as part of the probe data 230 from each connected vehicle 220, a set of estimated locations for each landmark 450 in the plurality of landmarks within the region 400. As shown in FIG. 2, for example, each of connected vehicle 220a, connected vehicle 220b, and connected vehicle 220c provides, in its output probe data 230 (230a, 230b, or 230c), an estimated location (e.g., latitude and longitude) of a particular landmark 450 (e.g., a traffic signal light). Those three somewhat different estimated locations for the traffic light constitute a set of estimated locations for that landmark 450. This generalizes to an environment including a plurality of landmarks 450, resulting in a set of estimated locations for each landmark 450 in a plurality of landmarks within the region 400.

Base-map generation module 520 generally includes instructions that, when executed by the one or more processors 505, cause the one or more processors 505 to generate a base zone map of the region 400 that represents roadways as edges and intersections as junctions (nodes or vertices). As discussed above, for a given region, base-map generation module 520 generates a base zone map, a graph in accordance with graph theory, in which roadways are represented as edges and intersections (places where roadways meet or cross each other) are represented as junctions (also called vertices or nodes by those skilled in the art). In some embodiments, the base zone map is generated using data from a map-data source such as OpenStreetMap®. As also explained above, the base zone map is generated once for a given region and is then updated periodically or as needed. The base zone map represents the basic geometry of the roadways and intersections in the region of interest. The trajectory of a given connected vehicle 220 during a trip (from the connected vehicle's probe data 230) can be matched to one or more edges in the base zone map. This is one of the first steps in the process of map building that map-data generation system 210 performs.

Data association module 525 generally includes instructions that, when executed by the one or more processors 505, cause the one or more processors 505 to transform, to edge-relative coordinates 545, the spatial coordinates of the set of estimated locations for each landmark 450 in the plurality of landmarks in the region 400. As discussed above in connection with FIG. 4, the edge-relative coordinates 545 are defined in terms of a distance 470 along an edge of the base zone map and an offset 460 from that edge to improve the GNN algorithm in performing data association to generate a final estimated location for each landmark 450 in the plurality of landmarks. In some embodiments, data association module 525 computes the final estimated location 350 for each landmark 450 in the plurality of landmarks as the centroid of the cluster of candidate locations 340 for that landmark 450.

As explained above, the improved data association by the GNN algorithm stems from the edge-relative coordinates 545 clarifying spatial relationships among the plurality of landmarks with respect to one or more edges in the base zone map to assist the GNN algorithm in identifying, from the sets of estimated locations for the landmarks in the plurality of landmarks, a cluster of candidate locations 340 for each landmark 450 in the plurality of landmarks. As discussed above in connection with FIGS. 3A, 3B, and 4, this is particularly helpful when landmarks are close to one another (e.g., two traffic signals at an intersection are in close proximity to each other), resulting in ambiguity in the actual locations of the landmarks due to interleaving of the clusters of estimated locations associated with the individual landmarks.

Output module 530 generally includes instructions that, when executed by the one or more processors 505, cause the one or more processors 505 to output a final zone map 240 that includes the final estimated location 350 for at least one landmark 450 in the plurality of landmarks. As discussed above, in some embodiments, multiple final zone maps 240 from different regions are combined to provide a map covering a larger geographical area (e.g., an entire town or city). As also discussed above, the final zone map 240 is used for localization, navigation, and/or path planning to control an autonomous vehicle 100, and the final zone map 240 can also be used for landmark inventory and change-detection, in some embodiments.

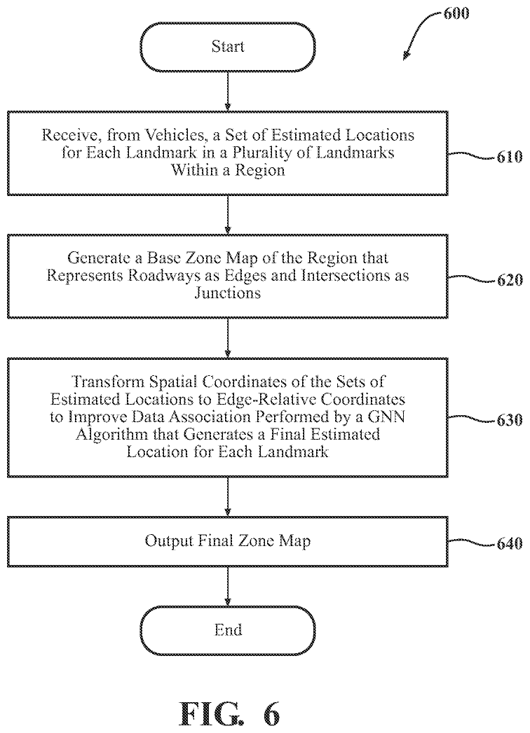

FIG. 6 is a flowchart of a method 600 of generating map data (e.g., map data 116 in vehicle 100), in accordance with an illustrative embodiment of the invention. Method 600 will be discussed from the perspective of the map-data generation system 210 in FIG. 5. While method 600 is discussed in combination with map-data generation system 210, it should be appreciated that method 600 is not limited to being implemented within map-data generation system 210, but map-data generation system 210 is instead one example of a system that may implement method 600.

At block 610, input module 515 receives, from one or more vehicles (220) that traveled within a region 400, a set of estimated locations for each landmark 450 in a plurality of landmarks within the region 400. As discussed above, input module 515 receives, via the wireless-network communication links 250 from the connected vehicles 220 as part of the probe data 230 from each connected vehicle 220, a set of estimated locations for each landmark 450 in the plurality of landmarks within the region 400. As shown in FIG. 2, for example, each of connected vehicle 220a, connected vehicle 220b, and connected vehicle 220c provides, in its output probe data 230 (230a, 230b, or 230c), an estimated location (e.g., latitude and longitude) of a particular landmark 450 (e.g., a traffic signal light). Those three somewhat different estimated locations for the traffic light constitute a set of estimated locations for that landmark 450. This generalizes to an environment including a plurality of landmarks 450, resulting in a set of estimated locations for each landmark 450 in a plurality of landmarks within the region 400.

At block 620, base-map generation module 520 generates a base zone map of the region that represents roadways as edges and intersections as junctions (vertices or nodes). As discussed above, for a given region 400, base-map generation module 520 generates a base zone map, a graph in accordance with graph theory, in which roadways are represented as edges and intersections (places where roadways meet or cross each other) are represented as junctions (also called vertices or nodes by those skilled in the art). In some embodiments, the base zone map is generated using data from a map-data source such as OpenStreetMap®. As explained above, the base zone map is generated once for a given region and is then updated periodically or as needed. The base zone map represents the basic geometry of the roadways and intersections in the region of interest. The trajectory of a given connected vehicle 220 during a trip (from the connected vehicle's probe data 230) can be matched to one or more edges in the base zone map. This is one of the first steps in the process of map building that map-data generation system 210 performs.

At block 630, data association module 525 transforms, to edge-relative coordinates 545, the spatial coordinates of the set of estimated locations for each landmark 450 in the plurality of landmarks. As discussed above in connection with FIG. 4, the edge-relative coordinates 545 are defined in terms of a distance 470 along an edge of the base zone map and an offset 460 from that edge to improve the GNN algorithm in performing data association to generate a final estimated location for each landmark 450 in the plurality of landmarks. In some embodiments, data association module 525 computes the final estimated location 350 for each landmark 450 in the plurality of landmarks as the centroid of the cluster of candidate locations 340 for that landmark 450.

As explained above, the improved data association by the GNN algorithm stems from the edge-relative coordinates 545 clarifying spatial relationships among the plurality of landmarks with respect to one or more edges in the base zone map to assist the GNN algorithm in identifying, from the sets of estimated locations for the landmarks in the plurality of landmarks, a cluster of candidate locations 340 for each landmark 450 in the plurality of landmarks. As discussed above in connection with FIGS. 3A, 3B, and 4, this is particularly helpful when landmarks are close to one another (e.g., two traffic signals at an intersection are in close proximity to each other), resulting in ambiguity in the actual locations of the landmarks due to interleaving of the clusters of estimated locations associated with the individual landmarks.

At block 640, output module 530 outputs a final zone map 240 that includes the final estimated location 350 for at least one landmark 450 in the plurality of landmarks. As discussed above, in some embodiments, multiple final zone maps 240 from different regions are combined to provide a map covering a larger geographical area (e.g., an entire town or city). As also discussed above, the final zone map 240 is used for localization, navigation, and/or path planning to control an autonomous vehicle 100, and the final zone map 240 can also be used for landmark inventory and change-detection, in some embodiments.

FIG. 1 will now be discussed in full detail as an example vehicle environment within which the systems and methods disclosed herein may be implemented. In some instances, the vehicle 100 can be configured to switch selectively between an autonomous mode, one or more semi-autonomous operational modes, and/or a manual mode. Such switching, also referred to as handover when transitioning to a manual mode, can be implemented in a suitable manner, now known or later developed. “Manual mode” means that all of or a majority of the navigation and/or maneuvering of the vehicle is performed according to inputs received from a user (e.g., human driver/operator).

In one or more implementations, the vehicle 100 can be an autonomous vehicle. As used herein, “autonomous vehicle” refers to a vehicle that operates in an autonomous mode. “Autonomous mode” refers to navigating and/or maneuvering a vehicle along a travel route using one or more computing devices to control the vehicle with minimal or no input from a human driver/operator. In one implementation, the vehicle 100 is configured with one or more semi-autonomous operational modes in which one or more computing devices perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route. Thus, in one or more implementations, the vehicle 100 operates autonomously according to a particular defined level of autonomy.

The vehicle 100 can include one or more processors 110. In one or more arrangements, the one or more processors 110 can be a main processor of the vehicle 100. For instance, the one or more processors 110 can be an electronic control unit (ECU). The vehicle 100 can include one or more data stores 115 for storing one or more types of data. The data store(s) 115 can include volatile and/or non-volatile memory. Examples of suitable data stores 115 include RAM, flash memory, ROM, PROM (Programmable Read-Only Memory), EPROM, EEPROM (Electrically Erasable Programmable Read-Only Memory), registers, magnetic disks, optical disks, hard drives, or any other suitable storage medium, or any combination thereof. The data store(s) 115 can be a component(s) of the one or more processors 110, or the data store(s) 115 can be operatively connected to the one or more processors 110 for use thereby. The term “operatively connected,” as used throughout this description, can include direct or indirect connections, including connections without direct physical contact.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can function independently from each other. Alternatively, two or more of the sensors can work in combination with each other. In such a case, the two or more sensors can form a sensor network. The sensor system 120 and/or the one or more sensors can be operatively connected to the one or more processors 110, the data store(s) 115, and/or another element of the vehicle 100 (including any of the elements shown in FIG. 1).

The sensor system 120 can include any suitable type of sensor. Various examples of different types of sensors will be described herein. However, it will be understood that the implementations are not limited to the particular sensors described. The sensor system 120 can include one or more vehicle sensors 121. The vehicle sensors 121 can detect, determine, and/or sense information about the vehicle 100 itself, including the operational status of various vehicle components and systems.

In one or more arrangements, the vehicle sensors 121 can be configured to detect, and/or sense position and/orientation changes of the vehicle 100, such as, for example, based on inertial acceleration. In one or more arrangements, the vehicle sensors 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensors 121 can be configured to detect, and/or sense one or more characteristics of the vehicle 100. In one or more arrangements, the vehicle sensors 121 can include a speedometer to determine a current speed of the vehicle 100.

Alternatively, or in addition, the sensor system 120 can include one or more environment sensors 122 configured to acquire, and/or sense driving environment data. “Driving environment data” includes any data or information about the external environment in which a vehicle is located or one or more portions thereof. For example, the one or more environment sensors 122 can be configured to detect, quantify, and/or sense obstacles in at least a portion of the external environment of the vehicle 100 and/or information/data about such obstacles. The one or more environment sensors 122 can be configured to detect, measure, quantify, and/or sense other things in at least a portion the external environment of the vehicle 100, such as, for example, nearby vehicles, lane markers, signs, traffic lights, traffic signs, lane lines, crosswalks, curbs proximate the vehicle 100, off-road objects, etc.

Various examples of sensors of the sensor system 120 are discussed above. The example sensors may be part of the one or more environment sensors 122 and/or the one or more vehicle sensors 121. Moreover, the sensor system 120 can include operator sensors that function to track or otherwise monitor aspects related to the driver/operator of the vehicle 100. However, it will be understood that the implementations are not limited to the particular sensors described. As an example, in one or more arrangements, the sensor system 120 can include one or more radar sensors 123, one or more LIDAR sensors 124, one or more sonar sensors 125, and/or one or more cameras 126.

The vehicle 100 can further include a communication system 130. The communication system 130 can include one or more components configured to facilitate communication between the vehicle 100 and one or more communication sources. Communication sources, as used herein, refers to people or devices with which the vehicle 100 can communicate with, such as external networks, computing devices, operator or occupants of the vehicle 100, or others. As part of the communication system 130, the vehicle 100 can include an input system 131. An “input system” includes any device, component, system, element or arrangement or groups thereof that enable information/data to be entered into a machine. In one or more examples, the input system 131 can receive an input from a vehicle occupant (e.g., a driver or a passenger). The vehicle 100 can include an output system 132. An “output system” includes any device, component, or arrangement or groups thereof that enable information/data to be presented to the one or more communication sources (e.g., a person, a vehicle passenger, etc.). The communication system 130 can further include specific elements which are part of or can interact with the input system 131 or the output system 132, such as one or more display device(s) 133, and one or more audio device(s) 134 (e.g., speakers and microphones).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combinations thereof, now known or later developed.

The one or more processors 110 and/or the autonomous driving module(s) 160 can be operatively connected to communicate with the various vehicle systems 140 and/or individual components thereof. For example, returning to FIG. 1, the one or more processors 110 and/or the autonomous driving module(s) 160 can be in communication to send and/or receive information from the various vehicle systems 140 to control the movement, speed, maneuvering, heading, direction, etc. of the vehicle 100. The one or more processors 110 and/or the autonomous driving module(s) 160 may control some or all of these vehicle systems 140 and, thus, may be partially or fully autonomous.

The vehicle 100 can include one or more modules, at least some of which are described herein. The modules can be implemented as computer-readable program code that, when executed by a processor 110, implement one or more of the various processes described herein. The processor 110 can be a device, such as a CPU, which is capable of receiving and executing one or more threads of instructions for the purpose of performing a task. One or more of the modules can be a component of the one or more processors 110, or one or more of the modules can be executed on and/or distributed among other processing systems to which the one or more processors 110 is operatively connected. The modules can include instructions (e.g., program logic) executable by one or more processors 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

In some implementations, the vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine the position and velocity of the vehicle 100. The autonomous driving module(s) 160 can determine the location of obstacles, or other environmental features including traffic signs, trees, shrubs, neighboring vehicles, pedestrians, etc.

The autonomous driving module(s) 160 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140). The noted functions and methods will become more apparent with a further discussion of the figures.

Detailed implementations are disclosed herein. However, it is to be understood that the disclosed implementations are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various implementations are shown in FIGS. 1-6, but the implementations are not limited to the illustrated structure or application.

The flowcharts and block diagrams in the figures illustrate the architecture, functionality, and operation of possible implementations of systems, methods, and computer program products according to various implementations. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can be executed substantially concurrently, or the blocks can sometimes be executed in the reverse order, depending upon the functionality involved.

The systems, components and/or methods described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or methods also can be embedded in a computer-readable storage, such as a computer program product or other data programs storage device, readable by a machine, tangibly embodying a program of instructions executable by the machine to perform methods and methods described herein. These elements also can be embedded in an application product which comprises all the features enabling the implementation of the methods described herein and, which when loaded in a processing system, is able to carry out these methods.

Furthermore, arrangements described herein can take the form of a computer program product embodied in one or more computer-readable media having computer-readable program code embodied or embedded, such as stored thereon. Any combination of one or more computer-readable media can be utilized. The computer-readable medium can be a computer-readable signal medium or a computer-readable storage medium. The phrase “computer-readable storage medium” means a non-transitory storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a RAM, a ROM, an EPROM or Flash memory, an optical fiber, a portable compact disc read-only memory (CD-ROM), a digital versatile disc (DVD), an optical storage device, a magnetic storage device, or any suitable combination of the foregoing. In the context of this document, a computer-readable storage medium can be any tangible medium that can contain, or store a program for use by, or in connection with, an instruction execution system, apparatus, or device.

Program code embodied on a computer-readable medium can be transmitted using any appropriate medium, including but not limited to wireless, wireline, optical fiber, cable, RF, etc., or any suitable combination of the foregoing. Computer program code for carrying out operations for aspects of the present arrangements can be written in any combination of one or more programming languages, including an object-oriented programming language such as Java™, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a LAN or a WAN, or the connection can be made to an external computer (for example, through the Internet using an Internet Service Provider).

In the description above, certain specific details are outlined in order to provide a thorough understanding of various implementations. However, one skilled in the art will understand that the invention may be practiced without these details. In other instances, well-known structures have not been shown or described in detail to avoid unnecessarily obscuring descriptions of the implementations. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one or more implementations” or “an implementation” means that a particular feature, structure or characteristic described in connection with the implementation is included in at least one or more implementations. Thus, the appearances of the phrases “in one or more implementations” or “in an implementation” in various places throughout this specification are not necessarily all referring to the same implementation. Furthermore, the particular features, structures, or characteristics may be combined in any suitable manner in one or more implementations. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings (such as “Background” and “Summary”) and sub-headings used herein are intended only for general organization of topics within the present disclosure and are not intended to limit the disclosure of the technology or any aspect thereof. The recitation of multiple implementations having stated features is not intended to exclude other implementations having additional features, or other implementations incorporating different combinations of the stated features. As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an implementation can or may comprise certain elements or features does not exclude other implementations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an implementation or particular system is included in at least one or more implementations or aspect. The appearances of the phrase “in one aspect” (or variations thereof) are not necessarily referring to the same aspect or implementation. It should also be understood that the various method steps discussed herein do not have to be carried out in the same order as depicted, and not each method step is required in each aspect or implementation.

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. The term “module,” as used herein, is not intended, under any circumstances, to invoke interpretation of the appended claims under 35 U.S.C. § 112(f).

The terms “a” and “an,” as used herein, are defined as one as or more than one. The term “plurality,” as used herein, is defined as two or more than two. The term “another,” as used herein, is defined as at least a second or more. The terms “including” and/or “having,” as used herein, are defined as including (i.e., open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

The preceding description of the implementations has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations should not be regarded as a departure from the disclosure, and all such modifications are intended to be included within the scope of the disclosure.

While the preceding is directed to implementations of the disclosed devices, systems, and methods, other and further implementations of the disclosed devices, systems, and methods can be devised without departing from the basic scope thereof. The scope thereof is determined by the claims that follow.

What is claimed is:

1. A system for generating map data, the system comprising:
a processor; and
a memory storing machine-readable instructions that, when executed by the processor, cause the processor to:
receive, from one or more vehicles that traveled within a region, a set of estimated locations for each landmark in a plurality of landmarks within the region;
generate a base zone map of the region that represents roadways as edges and intersections as junctions;
transform, to edge-relative coordinates, spatial coordinates of the set of estimated locations for each landmark in the plurality of landmarks, wherein the edge-relative coordinates are defined in terms of a distance along an edge of the base zone map and an offset from that edge to improve a Global Nearest Neighbor (GNN) algorithm in performing data association to generate a final estimated location for each landmark in the plurality of landmarks; and
output a final zone map that includes the final estimated location for at least one landmark in the plurality of landmarks;
wherein the final zone map is used for one or more of localization, navigation, and path planning to control an autonomous vehicle.

2. The system of claim 1, wherein the machine-readable instructions include further instructions that, when executed by the processor, cause the processor to compare the final zone map with an earlier version of the final zone map to identify and output changes in landmarks within the region.

3. The system of claim 1, wherein the set of estimated locations for each landmark in the plurality of landmarks is derived from perception systems in the one or more vehicles that process raw sensor data output by sensors in the one or more vehicles.

4. The system of claim 1, wherein the spatial coordinates include latitude and longitude and the landmarks in the plurality of landmarks include one or more of traffic signs, traffic signal lights, and roadway features.

5. The system of claim 1, wherein the spatial coordinates include latitude, longitude, and height above a ground level.

6. The system of claim 1, wherein the edge-relative coordinates improve the GNN algorithm in performing data association by clarifying spatial relationships among the plurality of landmarks with respect to one or more edges in the base zone map to assist the GNN algorithm in identifying, from the sets of estimated locations for the landmarks in the plurality of landmarks, a cluster of candidate locations for each landmark in the plurality of landmarks.

7. The system of claim 6, wherein the machine-readable instructions cause the processor to compute the final estimated location for each landmark in the plurality of landmarks as a centroid of the cluster of candidate locations for that landmark.

8. A non-transitory computer-readable medium for generating map data and storing instructions that, when executed by a processor, cause the processor to:
receive, from one or more vehicles that traveled within a region, a set of estimated locations for each landmark in a plurality of landmarks within the region;
generate a base zone map of the region that represents roadways as edges and intersections as junctions;
transform, to edge-relative coordinates, spatial coordinates of the set of estimated locations for each landmark in the plurality of landmarks, wherein the edge-relative coordinates are defined in terms of a distance along an edge of the base zone map and an offset from that edge to improve a Global Nearest Neighbor (GNN) algorithm in performing data association to generate a final estimated location for each landmark in the plurality of landmarks; and
output a final zone map that includes the final estimated location for at least one landmark in the plurality of landmarks;
wherein the final zone map is used for one or more of localization, navigation, and path planning to control an autonomous vehicle.

9. The non-transitory computer-readable medium of claim 8, wherein the instructions include further instructions that, when executed by the processor, cause the processor to compare the final zone map with an earlier version of the final zone map to identify and output changes in landmarks within the region.

10. The non-transitory computer-readable medium of claim 8, wherein the set of estimated locations for each landmark in the plurality of landmarks is derived from perception systems in the one or more vehicles that process raw sensor data output by sensors in the one or more vehicles.

11. The non-transitory computer-readable medium of claim 8, wherein the spatial coordinates include latitude and longitude and the landmarks in the plurality of landmarks include one or more of traffic signs, traffic signal lights, and roadway features.

12. The non-transitory computer-readable medium of claim 8, wherein the edge-relative coordinates improve the GNN algorithm in performing data association by clarifying spatial relationships among the plurality of landmarks with respect to one or more edges in the base zone map to assist the GNN algorithm in identifying, from the sets of estimated locations for the landmarks in the plurality of landmarks, a cluster of candidate locations for each landmark in the plurality of landmarks.

13. The non-transitory computer-readable medium of claim 12, wherein the instructions cause the processor to compute the final estimated location for each landmark in the plurality of landmarks as a centroid of the cluster of candidate locations for that landmark.

14. A method, comprising:
receiving, from one or more vehicles that traveled within a region, a set of estimated locations for each landmark in a plurality of landmarks within the region;
generating a base zone map of the region that represents roadways as edges and intersections as junctions;
transforming, to edge-relative coordinates, spatial coordinates of the set of estimated locations for each landmark in the plurality of landmarks, wherein the edge-relative coordinates are defined in terms of a distance along an edge of the base zone map and an offset from that edge to improve a Global Nearest Neighbor (GNN) algorithm in performing data association to generate a final estimated location for each landmark in the plurality of landmarks; and
outputting a final zone map that includes the final estimated location for at least one landmark in the plurality of landmarks;
wherein the final zone map is used for one or more of localization, navigation, and path planning to control an autonomous vehicle.

15. The method of claim 14, further comprising comparing the final zone map with an earlier version of the final zone map to identify and output changes in landmarks within the region.

16. The method of claim 14, wherein the set of estimated locations for each landmark in the plurality of landmarks is derived from perception systems in the one or more vehicles that process raw sensor data output by sensors in the one or more vehicles.

17. The method of claim 14, wherein the spatial coordinates include latitude and longitude and the plurality of landmarks include one or more of traffic signs, traffic signal lights, and roadway features.

18. The method of claim 14, wherein the spatial coordinates include latitude, longitude, and height above a ground level.

19. The method of claim 14, wherein the edge-relative coordinates improve the GNN algorithm in performing data association by clarifying spatial relationships among the plurality of landmarks with respect to one or more edges in the base zone map to assist the GNN algorithm in identifying, from the sets of estimated locations for the landmarks in the plurality of landmarks, a cluster of candidate locations for each landmark in the plurality of landmarks.

20. The method of claim 19, wherein the final estimated location for each landmark in the plurality of landmarks is computed as a centroid of the cluster of candidate locations for that landmark.
